(19) United States
(12) Patent Application Publication
(10) Pub. No.: US 2006/0047837 A1
(43) Pub. Date: Mar. 2, 2006

(54) Arrangement for informing application capabilities by an object exchange protocol

(76) Inventor: Jukka-Pekka Rissanen, Tampere (FI)

Correspondence Address: Hollingsworth & Funk, LLC, Suite 125, 8009 34th Avenue South, Minneapolis, MN, 55425, US

(21) Appl. No.: 10/866,859

(22) Filed: Jun. 14, 2004

(51) Int. Cl. G06F 15/16

(52) U.S. Cl. 709/230

(57) ABSTRACT

The invention relates to a method for informing application properties by an object exchange protocol. Properties of an application to be stored are determined as property information as a response to an addition or modification of the application in the data processing device. The property information is stored to a pre-determined storage for dynamic property information in the data processing device. The property information is retrieved from the pre-determined storage when there is a need to obtain property information for object exchange purposes for a requesting entity. The property information may be transmitted to the requesting entity by the object exchange protocol.

### FIELD OF THE INVENTION

The invention relates to informing application capabilities by an object exchange protocol and more precisely to informing capabilities of applications being added or modified.

### BACKGROUND OF THE INVENTION

Object exchange refers generally to exchange of objects such as files, pictures, calendar entries (vCal) and business cards (vCard). One well known specification for object exchange between devices is the OBEX (Object Exchange) specified by the IrDA™ (Infrared Data Association). Although OBEX was specified for infrared communication, it is very suitable to be used over many other transports services such as the TCP/IP and Bluetooth. OBEX is also referred to as IrOBEX when applied over the infrared medium. OBEX is especially optimal for ad-hoc wireless links. OBEX is utilized in many mobile devices such as mobile phones and PDA devices. As an example, OBEX may be used to serve SyncML layer functions arranging synchronization of data items between devices.

“IrDA Object Exchange Protocol IrOBEX”, version 1.2, Mar. 18, 1999, by the IrDA™ describes the OBEX protocol and an application framework. The OBEX protocol is a client-server session level protocol that specifies the structure for the conversation between devices. It also contains a model for representing objects. The OBEX application framework is built on top of the OBEX protocol. The OBEX application framework is a set of conventions and services designed for the purpose of creating interoperable devices.

The OBEX capability service is one of the OBEX application framework services and designed to provide a general-purpose method for accessing service information with OBEX. The capability service may list the types of objects supported and details about the fields or formats of specific types. By reading the OBEX server's capability object the OBEX client can determine the best format to send an object. The OBEX client can also determine if it makes sense to even send an object at all.

The capability service is based upon two OBEX objects, the capability object and the object profile object. The capability object contains general-purpose information about the device, including the services and applications that are supported. The object profile object contains information specific to the OBEX objects that the device supports.

The capability object comprises three main sections; general information, supported objects and service/application-info. The general section contains general information about the device. Information such as serial number and manufacturer are included in this section. The supported objects section is separated into two sub-sections. The first section, the Inbox, lists the objects that are recognized by the device's inbox for OBEX transactions. This allows a connected device to determine if the recipient will accept the object it wishes to send before it initiates the transmission. The supported objects section provides information about other objects that are used in the device but are not permissible in the inbox. The service info section is designed for use by applications that need to convey static configuration information. Information such as application version and supported options is recorded here.

The capability object is stored during manufacturing phase of a device. Thereafter, the capability object cannot be changed. However, many of the current devices enable subsequent installation of applications into the device afterwards. Hence, it is possible that information on some applications in the device after manufacturing is not available in the capability object. Thus another device, functioning as the OBEX client, does not get valid information about the capabilities of the other device when it receives the capability object.

### BRIEF DESCRIPTION OF THE INVENTION

There is now provided an improved solution for informing application capabilities. This improvement is achieved by a method, data processing devices and computer program products that are characterized by what is stated in the independent claims. Some embodiments of the invention are set forth in the dependent claims.

According to the invention, properties of an application to be stored are defined as property information as a response to an addition or modification of the application in the data processing device. The property information is stored to a storage for dynamic property information in the data processing device. The property information is retrieved from the storage when there is a need to obtain property information for a requesting entity. The property information may then be transmitted to the requesting entity by the object exchange protocol.

The reference to application properties is to be understood broadly to refer to any properties of a particular application, a group of applications or a service provided by an application. For instance, the application properties may be capabilities of an application specified in an OBEX capability object.

The arrangement of the invention provides the advantage that details of new or modified applications may be informed to other devices by object exchange protocol. This enables an easy update method for keeping one or more other devices up to date with the current properties of the device transmitting the property information. This updating can be arranged such that the user does not have to make any changes to the device, but the determination of properties and other steps may be made automatically as an application is added, modified, or deleted. According to an aspect of the invention, the other devices may then change their functionality according to the received (dynamic) property information. For instance, they may select an updated version of a software instead of an earlier used previous version, as a response to a received property information indicating the support for this new version.

According to an embodiment of the invention, the property information is stored to a pre-determined directory or file, and the entity responding to the request is configured to retrieve the property information from the pre-determined directory or file. Thus, it is not necessary to search for the property information from multiple locations (e.g. from the folders of all applications in the device), but all (dynamic) property information may be quickly retrieved from a single directory or file.

According to an embodiment of the invention, the property information is determined as a response to a new application being or having been installed. Thus the property information is always up to date including also the recently added applications.

### BRIEF DESCRIPTION OF THE FIGURES

The invention will now be described in greater detail by means of the preferred embodiments and with reference to the attached drawings, in which

FIG. 1 is a block diagram illustrating some object exchange scenarios,

FIG. 2 is a block diagram illustrating a device comprising OBEX functionality,

FIGS. 3a and 3b are flow charts of a method according to an embodiment of the invention,

FIG. 4 is a flow chart of a method according to an embodiment of the invention, and

FIG. 5 is a signalling diagram illustrating capability object transmission by OBEX capability exchange protocol.

### DETAILED DESCRIPTION OF THE INVENTION

Some embodiments of the invention are described in the following by means of object exchange at least partly according to the OBEX standard. The invention can, however, be applied to a system employing any object exchange technology.

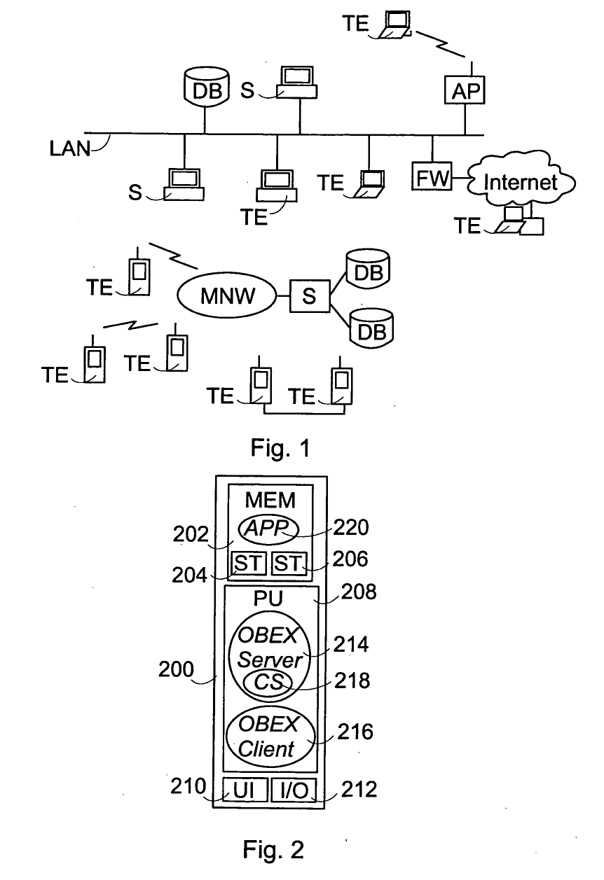

FIG. 1 illustrates a networked system, in which objects may be exchanged between storages of servers S and terminals TE, between terminals TE or between servers S. During the object exchange the requesting party is the client device and the responding party is the server. The data processing device TE, S carrying out the OBEX functions could be a network server, a PC (personal computer), a mobile phone, a laptop computer or a PDA device.

FIG. 1 shows some examples on possible object exchange scenarios, the first of which has terminals TE and servers S connected to a local area network LAN. The terminal TE connected to the network LAN comprises functionality, for instance a network card and software controlling data transmission, for communication with the devices in the network LAN. The local area network LAN can be any type of local area network and TE can also be connected to the server S through the Internet typically using a firewall FW. The terminal TE can also be connected wirelessly to the local area network LAN through an access point AP. In the second example, the terminal TE communicates with the server S through a mobile network MNW. The terminal TE connected to the network MNW comprises mobile communication functionality for communicating wirelessly with the network MNW. There may also be other networks, such as a local area network LAN, between the mobile network MNW and the server S. The mobile network MNW and the terminal TE may support some wireless network, such as a network supporting GSM services, a network supporting GPRS (General Packet Radio Service) services, a third-generation mobile network, such as one according to the 3GPP (3^{rd} Generation Partnership Project) network specifications, a wireless local area network WLAN or a private network. In addition to the examples of FIG. 1, other object exchange scenarios are naturally also possible.

FIG. 2 illustrates a data processing device 200 capable of functioning both as the OBEX client and as the OBEX server. The data processing device 200 may e.g. be a terminal TE or a server S as illustrated in FIG. 1. However, it is to be noted that some data processing devices 200 may comprise only the OBEX client 216 or the OBEX server 214 functionality. The device 200 comprises a memory (MEM) 202, a user interface (UI) 210, I/O means 212 for arranging I/O data transmission, and a processing unit PU 208 comprising one or more processors. The memory 202 has a non-volatile portion for storing applications controlling the processing unit 208 and other necessary information and a volatile portion for use in processing temporary data. The property information of applications 220 stored in the data processing device 200, especially the property information for one or more capability objects may be stored in the memory 202. In one embodiment substantially static property information is stored during manufacturing of the device 200 to a static memory portion such as ROM (read-only memory) or flash memory and property information on an application added later is stored to non-static part of memory such as the RAM (random access memory). However, it is to be noted that also other kinds of arrangements may be used. For instance, all property information may be stored to an erasable memory such as EEPROM (electrically erasable programmable read-only memory).

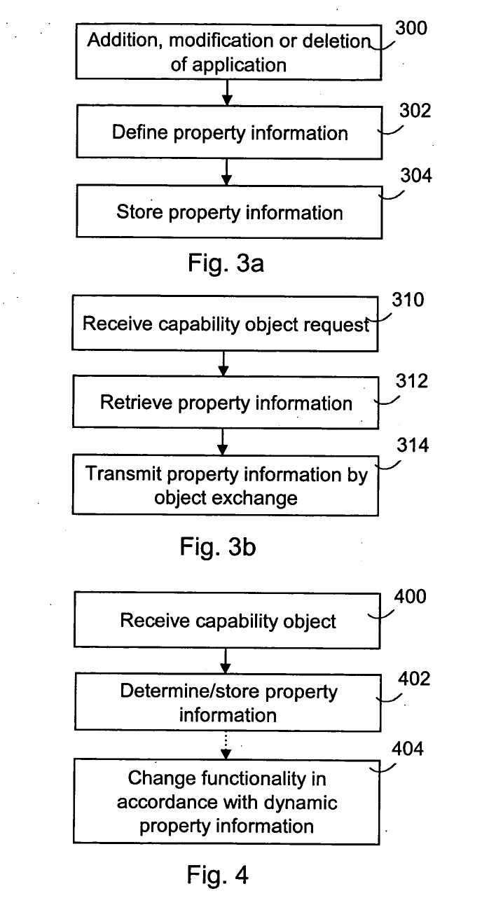

The OBEX client 216 and server 214 functionality can be implemented by executing a computer program code stored in the memory MEM of the processing unit 208. This applies also for the capability service (CS) 218 serving OBEX capability object requests from OBEX client (216) and retrieving property information stored in the memory 202. Computer program codes executed in the processing unit 208 may cause the data processing device 200 to implement at least part of the inventive functions, some embodiments of which are illustrated in more detail in connection with FIGS. 3a/b, 4, and 5. The computer program can be stored on any memory media, such as PC hard disk or a CD-ROM, from which it can be loaded into the memory 202 of the device 200. The computer program can also be loaded through a network by using a TCP/IP protocol stack, for instance. It is also possible to use hardware solutions or a combination of hardware and software solutions to implement the inventive means.

FIG. 3a is a flow chart illustrating method steps relating to storage of property information. The method can be applied in a data processing device (200) that comprises the OBEX server 214 functionality. In step 300 an application (220) in the data processing device 200 is added, modified, or deleted. In step 302 property information is defined. The property information may be determined by collecting information about predetermined properties of the application. In another embodiment this step involves selection of predetermined information, for instance a file in the application installation package, whereby the determination does not require any special application property searching means in the device 200. In one embodiment a property information for OBEX capability object is defined in the format illustrated in OBEX specifications, determining some basic elements for OBEX capability object. Depending on application properties, also other elements may be used in capability objects. This information determines the properties of the application, some examples are given in more detail later. This step may be done by the application itself or by the OBEX capability service 218 entity. The property information is stored in step 304 to a pre-determined storage for dynamic property information. In one embodiment the application or an installation or modification application for the application is configured to define the necessary property information and store it as an XML file to a pre-determined folder in the storage 204, 206. Thus the application may publish its information to be informed also to other devices.

FIG. 3b illustrates the functions when receiving a capability object request (step 310). On the basis of the capability object request, the data processing device 200 (in the present embodiment the capability service 218) retrieves 312 property information from the storage 204, 206. Typically the data processing device 200 comprises static property information already stored at manufacturing stage and in the present embodiment also dynamic property information preferably stored in accordance with FIG. 3a. As will be illustrated, different property information may reside in different storage locations, or a single file may be utilized. The data processing device 200 may retrieve the property information in step 312 on the basis of one or more pre-determined storage location settings, which may have been stored already at the manufacturing stage and/or when new dynamic property information has been stored. These properties may thus be collected run-time from the predefined directories or files after a request for the OBEX capability object is received. This step may involve collection of the property information into a single file and possible also some modification of the data format in order to comply with the format used for property information transmission. In the present embodiment the OBEX server 214 and more precisely the capability service 218 composes or retrieves an XML file which is the OBEX capability object. In step 314 the retrieved and possibly composed property information is transmitted to the requesting entity by an object exchange protocol, in the present embodiment by the OBEX protocol. The receiving device may then use the property information for adapting its functionality when communicating with the device from which the property information was received.

In one embodiment, the data processing device 200 is configured to store the dynamic property information to a pre-determined file or a directory. The application (which has been added or modified) or, in another embodiment the capability service CS 218, may add property information to this directory or file or store a replacing file. The capability service 218 is also configured to check this file or directory as a response to a received OBEX capability request and can select the contents of the file or directory as the property information to be transmitted to the requesting party, i.e. the OBEX client (216). This directory or file may in one embodiment be the same as the one used for storing static property information. In another embodiment at least two data storages are reserved for storing the property information. For instance, dynamically modifiable property information is stored in storage 206, whereas static property information is stored during manufacture in storage 204. In one further embodiment the storage position and/or file name is not predetermined in the data processing device 200 but the storage position and/or the file name is determined during the storage step of the property information in question. For instance, the capability service 218 determines the storage position for the new property information in step 302 and in or after step 304 stores a reference to the storage position and/or file in another place. This position could be reserved for settings controlling the functioning of the capability service 218.

In one embodiment the directory and/or the file in which the dynamic property information may be stored is protected by an access control mechanism. For instance, only certain entities may be allowed to access the property information. Further access conditions may be specified, such as whether modification of the folder or file is allowed. In one embodiment also third parties are allowed an access to at least some directory or folder to which they are allowed to store new application information. A property of an existing application may be modified and/or added by the application itself (or by its installation/modification program) instead of such a separate functionality being arranged in the device functioning as the OBEX server 214.

According to an embodiment, the application properties are SyncML application properties. These SyncML properties may be determined in a specific XML element which is stored in the storage for dynamic properties. These SyncML properties may then be sent as OBEX capability objects to a device functioning as an OBEX client (216), in one scenario also as a SyncML server. Below an example of such XML element for SyncML properties is given.

<Service>

<Name>SyncML</Name>
<UUID>SYNCML-SYNC</UUID>
<Version>1.1</Version>
<Object>

<Type>application/vnd.syncml+wbxml</Type>

</Object>

</Service>

UUID is an identifier for the SyncML service record.

According to another embodiment the application properties are file conversion service properties for which above illustrated features may be utilized and for which a separate <Service> element may be specified. This kind of application property may indicate the file types for which the device supports conversion. By the present dynamic property addition/exchange method this conversion property information may be updated and other devices may be informed about changes when new converters are installed.

FIG. 4 illustrates functions for a device receiving property information, in the present embodiment for an OBEX client (216) receiving a capability object. In step 400 the device receives a capability object as a response to a request sent earlier. Property information is determined and/or stored for later use in step 402. The property information may be used immediately or later upon a need in step 404. If the request has been done as there is a need to use some application by the OBEX client (216) device, at least some properties may be used immediately e.g. when setting up a connection to the application, and the property information is not necessarily stored. Since the properties may indicate capabilities of an application, information useful for selecting a correct protocol version, or settings for accessing the application or some API (application programming interface), for instance, the properties may affect the functioning of the OBEX server device in many ways, depending on the application and the respective property.

The capability object may comprise dynamic property information stored/retrieved by the OBEX server 214 device due to an addition, deletion, or modification of an application as already illustrated. Due to this new property information, the device functioning as the OBEX server changes at least one of its functions in accordance with the new property information. For instance, if the device notices that an indicated default connection method setting has been changed to a new one, the device changes its connection establishment control such that connection to the OBEX client device is established by a module providing connection according to the new connection method.

In one scenario the property information is utilized in the requesting/receiving device for controlling the functionality of a PIM application (Personal Information Manager). For instance, a PIM application such as the Nokia Datasuite for handling personal information in a mobile terminal by another device such as a PC, may change its functionality on the basis of property information of applications in the mobile terminal. This property information may be obtained by utilizing the above procedures and for instance local Bluetooth connection between the mobile terminal and the PC. The PIM application can get information about the available applications and their properties in the mobile terminal.

For instance, a SyncML application has been installed to a mobile terminal functioning as the OBEX server (214), whereby new property information has been added such that SyncML property information is included to OBEX capability objects returned from the device. When a device functioning as the OBEX client (216) receives such capability object, it changes its functionality as regards the SyncML service. The PIM application may be informed that the mobile terminal now supports SyncML. Further, information on how to arrange synchronization with the mobile terminal may now be obtained. The device/PIM application may store this information, possibly change its functionality such that it displays some indication on the newly supported SyncML service to the user. Further, it may change its functionality such that the device uses these properties when the user wishes to access contact information in the mobile terminal via the PIM application. In the present example the user may modify contact information which is then synchronized to the mobile terminal using the SyncML service.

In another embodiment changes to the SyncML application are made on the basis of the received property information. For instance, the SyncML application in the OBEX server (214) device is updated with a new version 1.2. Thus the device, e.g. the update software run in the device, replaces the original .xml file (indicating version 1.1) by a new .xml file including: <Version>1.1</Version>. Later, when an OBEX capability request is received from an OBEX client (216) device, the capability service 218 sends a capability object including this changed property information. When the OBEX client (216) device receives this information, it may change its functionality, when arranging a SyncML synchronization session with the OBEX server device, such that version 1.2 of the SyncML protocol is used. If necessary, the OBEX client device may on one further embodiment be arranged to download the new version of the SyncML protocol after receiving the OBEX capability object.

In one further embodiment relating to the SyncML application properties, element <Type> or some other element may indicate the content types (typically expressed as MIME (multi-purpose Internet mail extensions) types) which can be synchronized by the SyncML application. Plugins for different content types may be installed to a SyncML application later. Thus 3^{rd} party developers can later add support for new content types to be synchronized. In this case the plugin, the SyncML application, or some other entity in the device such as the capability service 218 may store the information on new content type to the property information. This could be done by adding the new content type information to the property file or folder or by replacing an existing property file by a file comprising the new content type. When the information about the new content type is received by a device functioning as the OBEX client (216), for instance by using the above illustrated OBEX capability object exchange procedure, the device may change its SyncML application functionality. This may be done by arranging the SyncML application to synchronize any data units of the new content type in next synchronization session. As the above examples illustrate, it is possible to describe and update in many ways properties relating to the applications and their services.

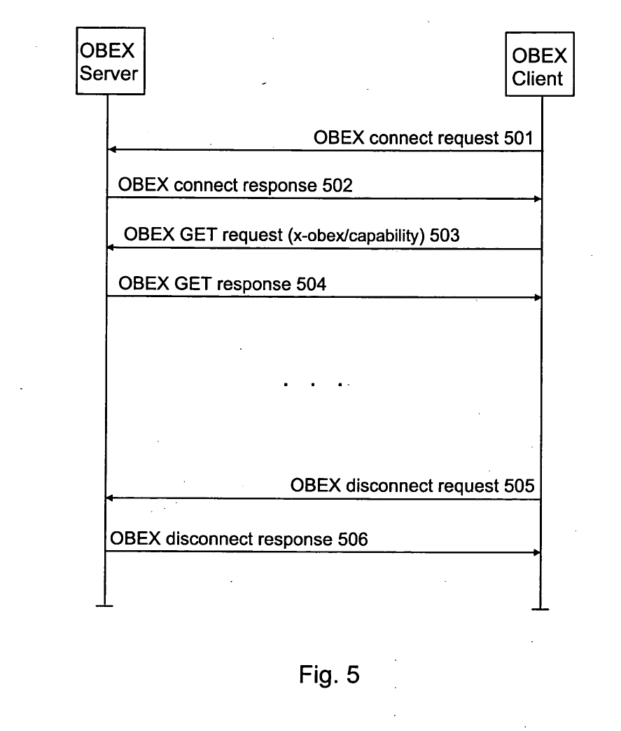

FIG. 5 illustrates the transmission of a capability object by the OBEX protocol. An OBEX connection is set up between OBEX client (216) and the OBEX server (214) as a response to the message 501 from the OBEX client (OBEX connect request). The capability service 218 can be connected by the message 501 including no targeting information. The OBEX server responds to this message by response message 502 (OBEX connect response).

The device functioning as the OBEX client needs to know application properties of the device functioning as the OBEX server and thus requests the OBEX capability object by message 503 (OBEX GET request with MIME type “x-obex/capability). The OBEX server, preferably the capability service 218, then retrieves all property information arranged to be included in the capability object and forms a response message for the OBEX client. This message 504 comprising the OBEX capability object is then transmitted from the OBEX server to the OBEX client.

Other procedures may be then carried out between the OBEX client and the OBEX server. When there is no remaining information to be transmitted, the OBEX connection can be released with messages 505 (OBEX disconnect request) and 506 (OBEX disconnect response). For more details on OBEX protocol features, reference is made to chapter 3 of the “IrDA Object Exchange Protocol IrOBEX”, version 1.2, Mar. 18, 1999, by the IrDA™, incorporated herein as a reference.

It is obvious to a person skilled in the art that while the technology advances, the basic idea of the invention can be implemented in many different ways. The invention and its embodiments are thus not restricted to the examples described above, but can vary within the scope of the claims.

1. A method for informing application properties by an object exchange protocol, wherein information on substantially static properties have been stored in data processing device, the method comprising:
defining one or more properties of an application to be stored as property information as a response to an addition or modification of the application in the data processing device,
storing the property information to a storage for dynamic property information in the data processing device,
retrieving the property information from the storage as a response to a need to obtain property information for a requesting entity, and
transmitting the property information to the requesting entity by the object exchange protocol.

2. A method as claimed in claim 1, wherein dynamic property information is stored to a pre-determined directory or file, and
the entity responding to the request from the requesting entity is configured to retrieve the property information from the pre-determined directory or file.

3. A method as claimed in claim 1, wherein the property information is determined as a response to a new application being or having been installed.

4. A method as claimed in claim 1, wherein at least one function of a device comprising the requesting entity is changed on the basis of the property information.

5. A data processing device comprising:
a storage for storing property information,
means for defining one or more properties of an application to be stored as property information as a response to an addition or modification of the application in the data processing device,
means for storing the property information to a storage for dynamic property information in the data processing device,
means for retrieving the property information from the storage as a response to a need to obtain property information for a requesting entity, and
data transmission means for transmitting the property information to the requesting entity by the object exchange protocol.

6. A data processing device as claimed in claim 5, wherein the data processing device is configured to store the property information to a pre-determined directory or file, and
an entity in the data processing device responding to the request for property is pre-configured to retrieve the property information from the pre-determined directory or file.

7. A data processing device as claimed in claim 6, wherein the data processing device is configured to store the property information to the same directory or file as the substantially static property information.

8. A data processing device as claimed in claim 5, wherein the application has been installed or is being installed, and the application is configured to determine and store the property information.

9. A data processing device as claimed in claim 5, wherein the application has been modified or is being modified, and the application is configured to determine and store the property information.

10. A data processing device as claimed in claim 5, wherein the data processing device is configured to alter the property information as a response to an existing application being removed, whereby an existing property information relating to the application is deleted or an information indicating that the application is deleted is stored.

11. A data processing device as claimed in claim 5, wherein the data processing device is configured to store a reference to the stored property information in connection with the storing of the property information, and
the data processing device is configured to retrieve the property information o the basis of the reference.

12. A data processing device as claimed in claim 5, wherein the object exchange protocol is OBEX and the data processing device comprises means for implementing OBEX capability service, whereby the OBEX capability service is configured to retrieve the property information as a response to a OBEX capability information request, and
the OBEX capability service is configured to reply with an OBEX capability object comprising the property information.

13. A data processing device comprising:
means for communicating with a second device by an object exchange protocol,
means for requesting property information from the second device by the object exchange protocol,
means for receiving property information from the second device, the property information comprising property information stored in the second device is connection with addition, modification or deletion of an application, wherein the data processing device is configured to change at least one function on the basis of the property information.

14. A data processing device as claimed in claim 13, wherein functionality of a PIM application (Personal Information Manager) is configured to be changed in the data processing device on the basis of the received property information.

15. A data processing device as claimed in claim 13, wherein the data processing device is configured to function as an OBEX client and receive the property information from the second device functioning as an OBEX server in a capability object.

16. A computer program comprising program code for controlling a data processing device when executed in a processor of the data processing device, wherein the computer program comprises:
a program code portion for controlling the data processing device to define one or more properties of an application to be stored as property information as a response to an addition or modification of the application in the data processing device,
a program code portion for controlling the data processing device to store the property information to a storage for dynamic property information in the data processing device,
a program code portion for controlling the data processing device to retrieve the property information from the storage as a response to a need to obtain property information for a requesting entity, and
a program code portion for controlling the data processing device to transmit the property information to the requesting entity by the object exchange protocol.

17. A computer program comprising program code for controlling a data processing device when executed in a processor of the data processing device, wherein the computer program comprises:
a program code portion for controlling the data processing device to request property information from the second device by an object exchange protocol,
a program code portion for controlling the data processing device to receive property information from the second device, the property information comprising property information stored in the second-device is connection with addition, modification or deletion of an application, and
a program code portion for controlling the data processing device to change at least one function on the basis of the property information.
